(19) United States
(12) Patent Application Publication
(10) Pub. No.: US 2006/0224444 A1
(43) Pub. Date: Oct. 5, 2006

(54) Networking advertisers and agents for ad authoring and/or ad campaign management

(76) Inventors: Ross Koningstein, Menlo Park, CA (US); Sumit Agarwal, San Carlos, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/093,422

(22) Filed: Mar. 30, 2005

(51) Int. Cl. G06Q 30/00

(52) U.S. Cl. 705/14

(57) ABSTRACT

As online ads are becoming technically and artistically more sophisticated, advertisers will need a way to efficiently request assistance with ad creations that offer richer ad formats. An online ad business environment helps connect advertisers with ad service providers (also called agents or advisors) who can meet their needs for more complex and sophisticated ad creatives. The online ad business network may use a job listing board where advertisers can enter request for assistance and agent can view them. The business network may also include an agent directory where agents can post their profiles and services and advertisers can view them. Using the job listing board and agent directory, advertisers and agent can contact each other through contact operations available in the business network, and enter into business relationships. A payment from an advertiser to an agent may be made via the business network. The amount of compensation paid to the agent by the business network need not be equal to the amount of payment received by the advertiser.

### §1. BACKGROUND OF THE INVENTION

§1.1 Field of the Invention

The present invention concerns helping advertisers to create ads and manage ad campaigns. In particular, the present invention concerns helping advertisers by creating a business network where advertisers and third parties specializing in ad creatives and/or ad campaign management can form business relationships and/or collaborate.

§1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword relevant advertising, such as the AdWords advertising system by Google of Mountain View, Calif., has been used by search engines. Similarly, content-relevant advertising systems have been proposed. Such systems serve ads relevant to the content of a document, such as a Web page for example. AdSense, from Google of Mountain View, Calif. is an example of an ad serving system that uses content targeted ads.

Simple text ads have been common in targeted ad serving systems. Such simple text ads have been popular with many smaller advertisers since they are easy to author. Indeed, it is believed by some that a key driver of the success of keyword-based text-advertising was the ease with which short text ads can be created. However, as ad delivery systems offer richer ad formats than traditional short text ads, advertisers will likely need a way to efficiently request assistance with ad creation. This poses a problem when ad formats become richer and heavier. Authoring compelling ad creatives becomes something that may require specialized talents. It would therefore be useful to help advertisers make full and effective use of ad delivery systems that serve ads having more sophisticated formatting and content.

### §2. SUMMARY OF THE INVENTION

An online ad business environment helps connect advertisers with ad service providers (also called agents or advisors) who can meet their needs for more complex and sophisticated ad creatives. The online ad business network may use a job listing board where advertisers can enter request for assistance and agent can view them. The business network may also include an agent directory where agents can post their profiles and services and advertisers can view them. Using the job listing board and agent directory, advertisers and agent can contact each other through contact operations available in the business network, and enter into business relationships. A payment from an advertiser to an agent may be made via the business network. The amount of compensation paid to the agent by the business network need not be equal to the amount of payment received by the advertiser.

One embodiment consistent with the present invention provides a method (or means) that (a) provides a first interface for allowing agents to create and edit a listing, (b) stores a plurality of listings created via the first interface, and (c) provides a second interface for allowing advertisers to view the listings.

One embodiment consistent with the present invention provides a method (or means) that (a) provides a first interface for allowing advertisers to create and edit an advertising job listing, (b) stores a plurality of job listings created via the first interface, and (c) provides a second interface for allowing agents to view the job listings.

One embodiment consistent with the present invention provides a method (or means) that (a) provides a first interface for allowing agents to store preliminary adverting campaign information, (b) stores a plurality of sets of preliminary advertising campaign information stored via the first interface, and (c) provides a second interface for allowing advertisers to view at least one of the sets of preliminary advertising campaign information.

One embodiment consistent with the present invention provides a method (or means) for use in an environment in which a business network facilitates business relationships or transactions between advertisers and agents for authoring advertisements and/or managing ad campaigns, in which the business network provides at least one of (A) compensation to the agent for the work done and (B) a subsidy to the advertiser.

### §3. BRIEF DESCRIPTION OF THE DRAWINGS

FIG. 1 is a diagram showing parties or entities that can interact with an online ad business network.

FIG. 2 is a bubble diagram of exemplary operations which may form a part of an online ad business network and which may be performed in a manner consistent with the present invention, as well as information that may be used and/or generated by such operations.

FIG. 3 is a bubble diagram of exemplary operations which may form a part of an online ad business network and which may be performed in a manner consistent with the present invention, as well as information that may be used and/or generated by such operations.

FIG. 4 illustrates an exemplary Webpage depicting a possible agent directory.

FIG. 5 is a flow diagram of an exemplary method that may be used to perform advertiser user interface operations in a manner consistent with the present invention.

FIG. 6 is a flow diagram of an exemplary method that may be used to perform agent user interface operations in a manner consistent with the present invention.

FIG. 7 is a flow diagram of an exemplary method that may be used to manage an agent directory in a manner consistent with the present invention.

FIG. 8 is a flow diagram of an exemplary method that may be used to manage job listings in a manner consistent with the present invention.

FIG. 9 is a flow diagram of an exemplary method that may be used to manage contracts in a manner consistent with the present invention.

FIG. 10 is a flow diagram of an exemplary method that may be used to manage proto ads in a manner consistent with the present invention.

FIG. 11 is a block diagram of exemplary apparatus that may be used to perform at least some operations and store at least some information in a manner consistent with the present invention.

### §4. DETAILED DESCRIPTION

The present invention may involve novel methods, apparatus, message formats, and/or data structures for providing an online ad business network where advertisers and third party service providers can enter into business relationships and/or collaborate. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, definitions of terms that may be used in this application are provided in §4.1. Then, environments in which, or with which, the present invention may operate are described in §4.2. Thereafter, exemplary embodiments of the present invention are described in §4.3. Finally, some conclusions regarding the present invention are set forth in §4.4.

### §4.1 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has a unique, addressable, storage location and can therefore be uniquely identified by this addressable location. A universal resource locator (URL) is a unique address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### §4.2 Enviroments in which, or with which, the Present Invention may Operate

Embodiments consistent with the present invention may be used in the context of an online advertising delivery system, such as AdWord or AdSense from Google for example.

### §4.3 Exemplary Embodiments

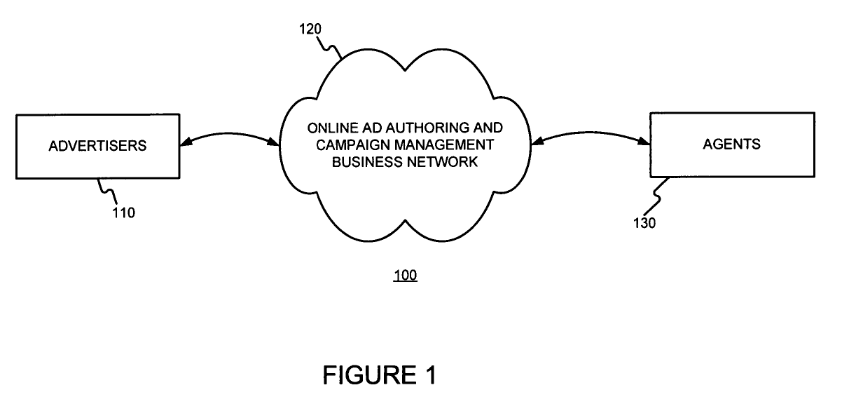

FIG. 1 is a diagram of an online ad business environment 100. Such an environment 100 may be used to help advertisers 110 to efficiently generate online ads, even complex ad creatives, and/or to efficiently manage ad campaigns, by using the assistance of advertising service providers (hereafter referred to as “agents”) 130. As a result, the online ad business network environment 100 may help to provide better, more sophisticated and higher quality advertising. Advertisers 110 may benefit from such a network 120 since they should be able to obtain sophisticated, high quality ads, even when they themselves lack the experience to produce such ads. Such ads should lead to better end user response to their products or services. Agents 130, particularly those with relevant experience, and/or a good reputation, may benefit by being able to offer their services to a receptive audience.

The online ad business environment 100 includes online ad business (e.g., authoring, campaign management, etc.) network 120, advertisers 110, and agents 130. The online ad business network 120 facilitates business between advertisers 110 and agents 130. Advertisers 110 may submit requests for assistance with ad creatives and/or ad campaigns, may browse attributes of various agents 130, may enter into business relationships with agents, and/or may collaborate with agents. Agents 130 may include third party service providers specializing in the development of ads and ad campaigns, and/or the management of ad campaigns. Agents 130 may receive requests from advertisers 110, may browse job postings from advertisers, may post information about them or their firm, may enter into business relationships with advertisers, and/or may collaborate with advertisers through the business network 120.

The online ad business network 120 may be a Web-based clearinghouse in which advertisers 110 submit job requests and through which agents 130 respond to requests. The online ad business network 120 may include a job listing board and a directory of agents. It 120 may also include other pertinent information and functions to help all parties to reach agreements and conduct business. Properties and functions that may be part of an exemplary online ad business network 120 will be introduced below.

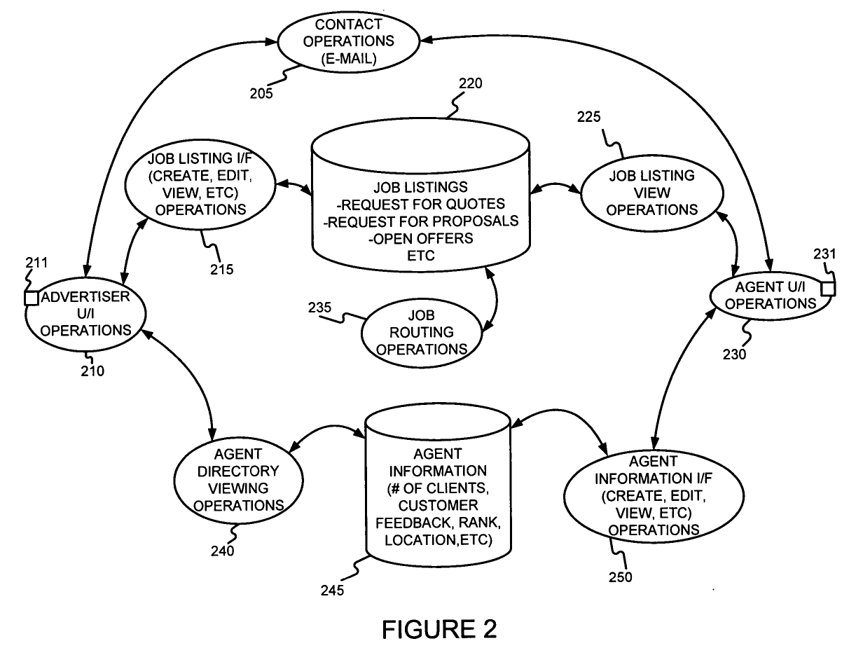

FIG. 2 is a bubble diagram of exemplary operations, which may form a part of the online ad business network, and which may be performed in a manner consistent with the present invention, as well as information that may be used and/or generated by such operations. As shown, an exemplary ad business network may store job listings 220 and/or agent information 245. The exemplary system may support contact operations 205, advertiser user interface operations 210, job listing interface operations 215, job listing view operations 225, agent user interface operations 230, job routing operations 235, agent directory viewing operations 240, and agent information interface operations 250.

Advertisers 110 may interface with the system via the advertiser user interface operations 210 as indicated by access point 211. Agents 130 may interface with the system via the agent user interface operations 230 as indicated by access point 231. Thus, advertiser 110 and agent 130 inputs to the system, and system outputs to the advertisers 110 and agents 130, may be accomplished through the advertiser user interface 210 and agent user interface 230, respectively.

The job listing interface operations 215 may be used to allow advertisers 110 to create, edit, and/or view a job listing (e.g., a request for assistance in creating an ad, or manage an ad campaign according to their needs). Thus, the job listing information 220 can be entered and managed via the job listing interface operations 215. The job listing information 220 may contain various requests made by advertisers such as, request for quotes, request for proposals, open offers, etc. The job listing view operations 225 may be used to allow agents 130 to view (and perhaps respond to) the job listing information 220. Therefore, the agents 130 may inspect the job opportunities posted by the advertisers 110 and take steps to enter into a business relationship with advertisers.

The agent information interface operations 250 may be used to allow agents 130 to create, view, and/or edit information about themselves or their agency. Thus, the agent information 245 can be entered and managed via the agent information interface 250. The agent information 245 may contain a directory of agents with pertinent information regarding their services. The agent information 245 may contain data about the agents 130 such as, for example, services offered, number of clients served, length of time providing services, customer feedback, ranking, amount of money managed (e.g., per ad or ad campaign), number of employees, one or more performance metrics, etc. The agent information may also include, for example, location of agent or agency, contact information, portfolio information, etc. The agent directory viewing operations 240 may be used by advertisers 110 to view the agent information 245. Therefore, the advertisers 110 may inspect information about available agents 130, such as services offered, qualifications, experience, etc. Contact operations 205 may be used to facilitate communications between the agents 130 and advertisers 110.

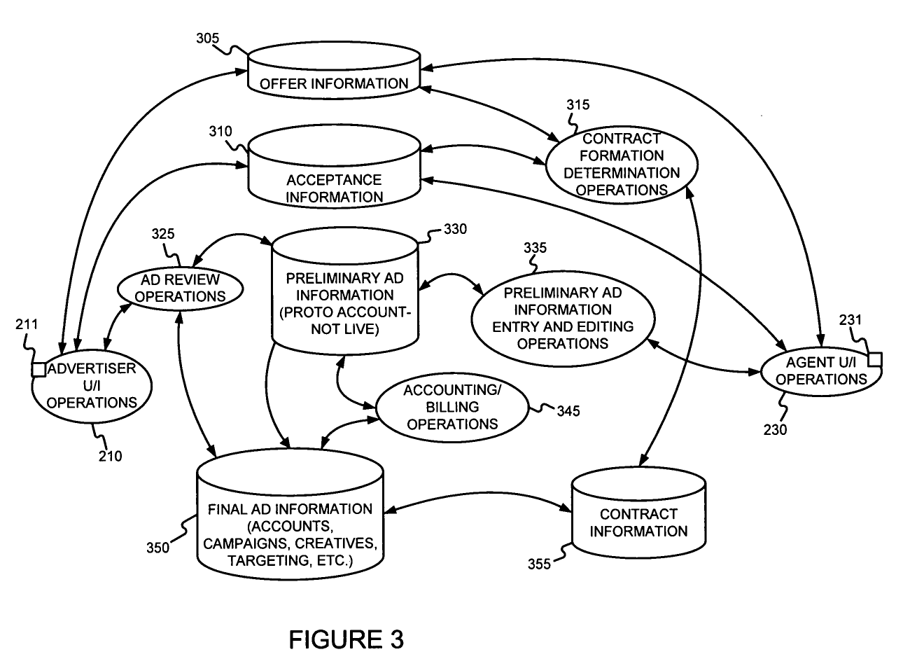

FIG. 3 is a bubble diagram of exemplary operations, which may form a part of an online ad business network, and which may be performed in a manner consistent with the present invention, as well as information that may be used and/or generated by such operations. As shown, an exemplary online ad business network may further store offer information 305, acceptance information 310, preliminary ad information 330, final ad information 350, and/or contract information 355. The exemplary system may further include contract formation determination operations 315, ad review operations 325, preliminary ad information entry and editing operations 335, and accounting/billing operations 345.

As was shown in FIG. 2, advertisers 110 may interface with the system via the advertiser user interface 210 as indicated by access point 211 and agents 130 may interface with the system via the agent user interface 230 as indicated by access point 231. Thus, advertiser 110 and agent 130 inputs to the system, and system outputs to the advertisers 110 and agents 130, may be accomplished through the advertiser user interface 210 and agent user interface 230, respectively.

The offer information 305 may contain information about offers from either an agent 130 or an advertiser 110. Offer information 305 may include, for example, compensation the advertiser is willing to pay, compensation required by the agent, specifics of the requested ad or ad campaign, specifics of when various work is to be done, etc. The acceptance information 310 may include information indicating that an advertiser 110 or agent 130 intends or wants to accept an offer. For instance, an advertiser 110 might accept or decline an agent's offer, or provide a counter-offer. Similarly, the agent 130 might accept or decline an advertiser's offer, or may provide a counter-offer. The contract formation determination operations 315 may use the offer information 305 and the acceptance information 310 to determine whether or not a contract between an advertiser and agent has been formed. If contract formation determination operations 315 have determined that a contract has been formed, they 315 may update the contract information 355. The contract information 355 may contain information about a contract. Contract information 355 may include, for example, the parties to the contract, when the contract was formed, compensation, time for performance, conditions to performance, other terms of a contract, etc.

The ad review operations 325 may be used by advertisers 110 to view (and possibly approve, annotate, edit, etc.) preliminary ad information submitted by agents 130. Also the ad review operations 325 may be used by the advertisers 110 to examine final ad information. The preliminary ad information 330 may contain preliminary ad information (also referred to as “proto ad accounts”) submitted by the agents 130 for the advertisers to review. In at least some embodiments consistent with the present invention, these proto ad accounts are not live—that is, they are not available to be served to end users. The preliminary ad information 330, in conjunction with ad review operations 325, can be used to provide a reviewing platform that allows advertisers to inspect the ads and to provide feedback to the agents 130 as to what they like or don't like, or what they would like to modify. The preliminary ad information entry and editing operations 335 may be used by the agents to enter their work in the preliminary ad information 330, view their work, view advertiser 110 edits or annotations of their work, and/or edit proto account information if necessary. Upon advertiser acceptance of a proto ad campaign 330, the preliminary ad information 330 may be saved as final ad information 350 (e.g., using ad review operations 325). The final ad information 350 may contain the final ad campaign approved and agreed upon by the advertisers and agents and may contain such information as account information, campaign information, ad creatives, targeting information, offers for action (e.g., impression, selection, conversion), budgets, etc.

Referring back to accounting/billing operations 345, advertiser payment for agent services and/or agent compensation for such services may take place via the online ad authoring and campaign management business network 120 (referred to simply as “the business network 120” below). The particulars of such operations 345 may depend on which one of a number of alternative compensation methods is used. For example, in a first exemplary embodiment, an advertiser may submit payment for agent services to the business network 120, and the business network 120 may provide compensation to the appropriate agent.

The compensation provided to the agent may be determined using the payment by the advertiser, and/or may be determined using one or more other factors, such as ad campaign performance or performance improvement for example. For example, in at least one embodiment consistent with the present invention, the compensation paid to the agent may be equal to, or substantially equal to, the payment received from the advertiser. In this case, the business network 120 would act like a “conduit” through which payment passes from the advertiser to the agent. Alternatively, the compensation paid to the agent may be less than or more than the payment received from the advertiser. If the compensation paid to the agent is more than the payment received from the advertiser, the business network 120 subsidizes the payment, likely with the belief that it will recoup the subsidy (e.g., from an increase in ad serving revenues, from a payment from a separate ad serving entity, etc.). In at least one embodiment consistent with the present invention, the business network 120 might totally subsidize the cost, in which case the advertiser would pay nothing. Indeed, in at least one embodiment consistent with the present invention, the business network 120 might in fact pay the advertiser (e.g., in addition to the agent). This allows the business network 120 to grow its network in the belief that it will recoup this payment to the advertiser. The payment of such a subsidy may be limited to certain situations (e.g., for an advertiser with a large, preferable committed advertising budget). If the compensation paid to the agent is less than the payment received from the advertiser, this could be thought of providing compensation to the business network 120 for matching the advertiser and agent.

In at least one embodiment consistent with the present invention, the compensation to the agent paid by the business network 120 may include multiple components. For example, one component of the compensation may be a fixed percentage of the amount charged to (paid by) the advertiser. Another component, or an alternative component, of the compensation could be a fixed or flat fee. Another component, or an alternative component, of the compensation may be a variable component, such as a bonus determined using a performance or a performance improvement of the advertising campaign. For example, performance of an ad campaign may be in expressed in terms of one or more of impressions, selections, conversions, revenue, expected revenue, etc. Performance improvement may be determined with respect to a previous ad campaign of the advertiser, or some other baseline (e.g., an aggregate of (e.g., all) other ad campaigns). In this way, such a variable component of the compensation to the agent may reflect the value that the agent has given to the advertiser (and/or to the ad serving system).

The time at which the business network 120 compensates the agent may be substantially concurrent with, or just after, the advertiser makes its payment. Alternatively, or in addition, the business network 120 may provide some or all components of compensation to the agent before the advertiser makes its payment. Alternatively, or in addition, the business network 120 may provide some or all components of compensation to the agent substantially after the advertiser makes its payment. Under such a scenario, the business network 120 could provide a stream of payments to the agent (e.g., based on performance or performance increase of the ad campaign). Indeed, it is possible for the agent to pay the business network 120 in exchange for the right to such (e.g., potential) future payments.

The business network 120 may determine compensation and time compensation payments to agents uniformly across all advertisers and agents. Alternatively, the business network 120 may determine compensation differently, and/or time compensation payments differently, for different advertisers, different agents, and/or different advertiser-agent pairs.

In at least one embodiment consistent with the present invention, the business network 120 may subsidize, to some extent, the Advertiser's payment to the Agent (e.g., compensation to agent>payment received from advertiser). The business network 120 may provide such subsidies with the expectation that it (or an affiliated ad serving network) will more than make up the difference in increased revenues due to increased impressions, selections, and/or conversions. Such a subsidy may be in the form of a bonus at the time of initial compensation of the agent, and/or at some later time when ad campaign performance and/or performance increases can be determined.

In at least one embodiment consistent with the present invention, the business network 120 may simply charge the Advertiser a predetermined or percentage amount more (or less) than it pays to the Agent.

In at least one embodiment consistent with the present invention, the business network may simply act as a “conduit for payment”, in which case the compensation paid to the agent is equal (or substantially equal) to the payment received from the advertiser.

Various other combinations of the foregoing compensation determination and timing techniques are possible and will be apparent to those skilled in the art.

### §4.3.1 Exemplary Agent Information

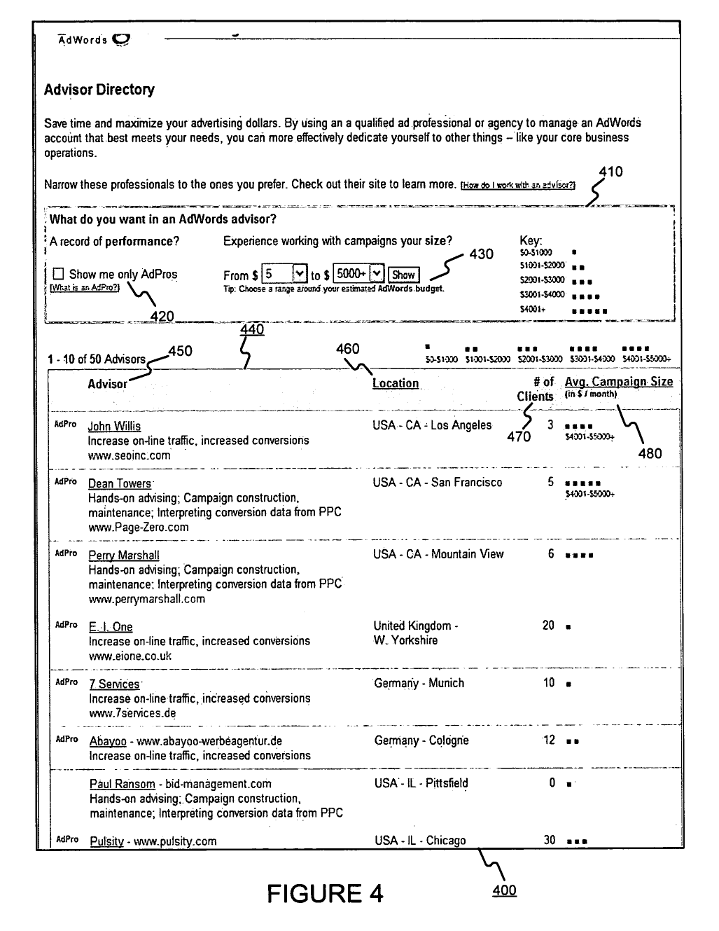

FIG. 4 illustrates an exemplary Webpage 400 including an exemplary agent directory (also referred to as “advisor directory”) which may be viewed by an advertiser. The business network may use such a directory to enable advertisers to search for suitable agents easily. Doing so further assists the agents in advertising their services and capabilities, and in general helps all parties to enter into business relations.

The Webpage 400 includes two sections. Section 410 and section 440. Section 410 includes interactive means for filtering and/or sorting agents. Section 440 illustrates exemplary filtering/sorting results that advertisers may view after conducting a search using the filtering/sorting parameters provided in section 410.

The section 410 may be used by advertisers to enter characteristics desired in an agent (so as to be capable of delivering the advertiser's demands) and search for those agents. For instance, an advertiser may request a record of performance (not shown) and/or highly experienced agents deemed to be “Pro's” by selecting the checkbox 420. The record of performance may include such statistics as number of clients, customer feedback, ranking, ratings, etc. These same statistics may also be used by the system to define highly experienced professional agents (“Pro's”). Also an advertiser can select a desired size range of campaigns that agents have experience working with from drop-down menus 430. Hence, advertisers can view results of agent listings that are presented according to their filtering/sorting parameters entered via such means as checkbox 420 and drop-down menus 430.

Various embodiments consistent with the present invention may provide other means for searching for appropriate agents, which may facilitate the entry of more or less search parameters.

Directory section 440 may include a number of entries, each of which may include advisor (also called agent) information 450, location 460, number of clients 470, and average campaign size of agent 480. The agent listing 450 may include the name of the agent and/or agency name, as well as descriptive text and links to landing pages (typically the Website of the agent). Hence, advertisers can get further information about the agent's capabilities and service qualities. The location listing 460 contains location information of agents such as country, state, and city. The last column 480 contains information about the size of campaigns that the agents have worked on (e.g., measured as amount of dollars per month).

Various embodiments consistent with the present invention may include different agent information, and may present such in different ways.

### §4.3.2 Exemplary Methods

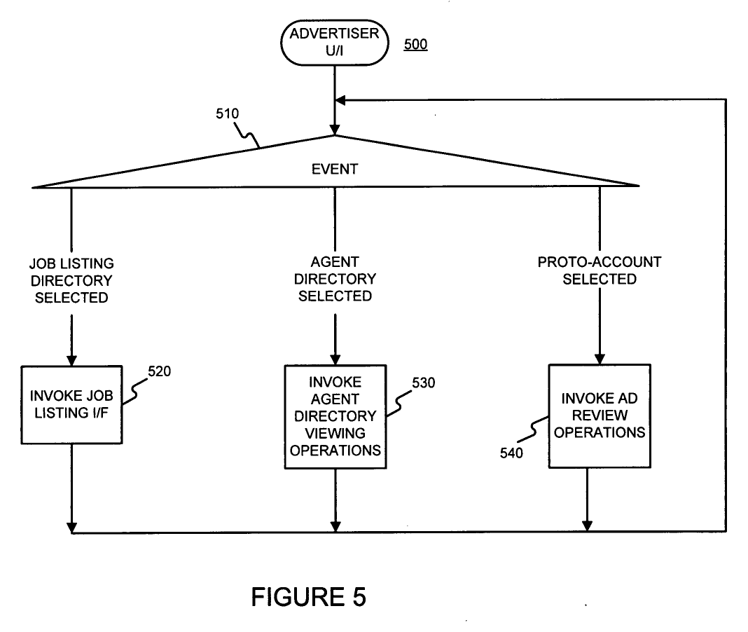

FIG. 5 is a flow diagram of an exemplary method 500 that may be used to perform the advertiser user interface operations 210 in a manner consistent with the present invention. Different branches of the method 500 may be performed in response to different events that can occur. (Block 510) One event can be the selection of the job listing directory. Upon the occurrence of this event, the method 500 may invoke job listing interface operations (Recall, e.g., 215 of FIG. 2.) to allow the advertiser to view (and perhaps respond to) the job listings (Recall, e.g., 220 of FIG. 2.). (Block 520) The method 500 then branches back to event block 510.

Another event may be the selection of the agent directory. Upon the occurrence of this event, the method 500 may invoke the agent directory viewing operations (Recall, e.g., 240 of FIG. 2.) to allow the advertiser to view (and perhaps respond to) agent information (Recall, e.g., 245 of FIG. 2.). (Block 530) The method 500 then branches back to event block 510.

Yet another event that may occur is the selection of a proto-account (Recall, e.g., preliminary ad information 330). Upon the occurrence of this event, the method 500 may invoke ad review operations (Recall, e.g., 325 of FIG. 3.) to allow the advertiser to view (and perhaps respond to) the preliminary ad information 330. (Block 540) The method 500 then branches back to event block 510.

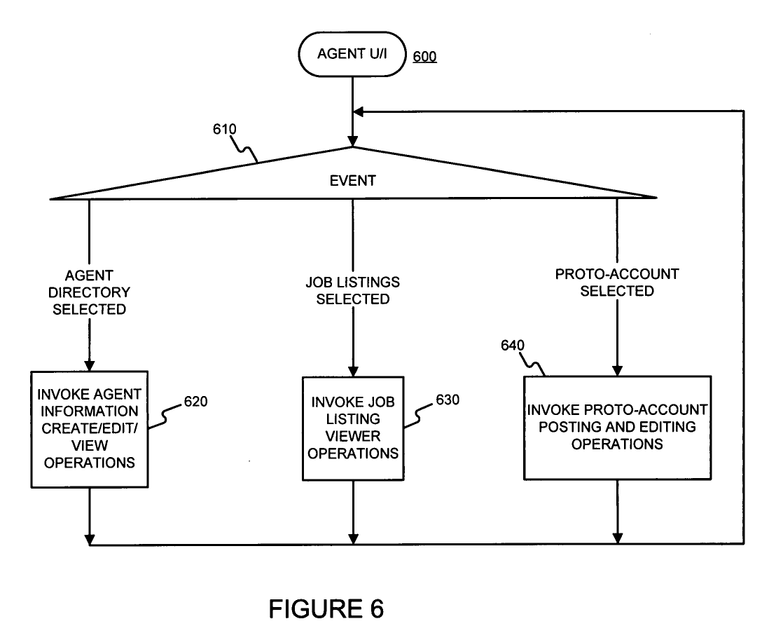

FIG. 6 is a flow diagram of an exemplary method 600 that may be used to perform the agent user interface operations 230 in a manner consistent with the present invention. Different branches of the method 600 may be performed in response to different events that can occur. (Block 610) One event may be the selection of the agent directory (Recall, e.g., 245 of FIG. 2.). Upon the occurrence of this event, the method 600 may invoke agent information create/edit/view operations (Recall, e.g., 250 of FIG. 2.) to allow the agent to create, edit, and/or view the agent information. (Block 620) The method 600 then branches back to event block 610.

Another event may be the selection of the job listings (Recall, e.g., 220 of FIG. 2.). Upon the occurrence of this event, the method 600 may invoke job listing viewing operations (Recall, e.g., 225 of FIG. 2.) to allow the agent to view (and perhaps respond to) the job listings. (Block 630) The method 600 then branches back to event block 610.

Yet another event that may occur is the selection of a proto account. (Recall, e.g., preliminary ad information 330.) Upon the occurrence of this event, the method 600 may invoke preliminary ad information entry and editing operations (Recall, e.g., 335 of FIG. 3.) to allow the agent to view (and perhaps edit) the preliminary ad information. (Block 640) The method 600 then branches back to event block 610.

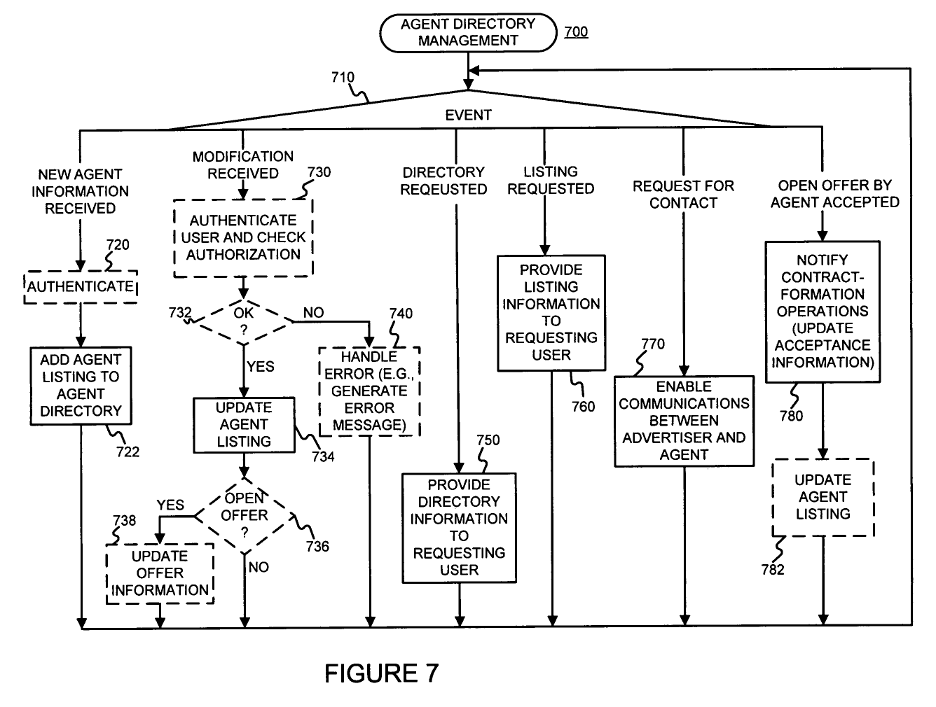

FIG. 7 is a flow diagram of an exemplary method 700 that may be used to perform agent directory management (Recall, e.g., 250 of FIG. 2.) in a manner consistent with the present invention. Different branches of the method 700 may be performed in response to different events that may occur. (Block 710) One event that may occur is the receipt of the new agent information. If new agent information is received, the method 700 may authenticate the new agent information and add the agent listing to the agent directory before branching back to block 710. (Blocks 720 and 722)

Another event that may occur is the receipt of modifications (or a request to make modifications) made to the agent listings and offers. If a modification made by an agent is received, the method 700 may authenticate the user (agent) and check the user's authorization. (Blocks 730 and 732) If the agent does not pass the inspection, an error handling procedure may be performed (e.g., an error message may be generated and provided to the agent). (Block 740) If, on the other hand, the agent passes the inspection, the method 700 may update the agent listing using the received modifications. (Block 734) Furthermore, if the modification includes an open offer, the method 700 may update offer information (Recall, e.g., 305 of FIG. 3.) before branching back to Block 710. (Blocks 736 and 738) If the modification does not include an open offer, the method will simply branch back to Block 710. (Block 736)

Another event that may occur is the receipt of a directory request. Upon the occurrence of this event, the method 700 may provide the directory information to the requesting user (advertiser or agent). (Block 750) The method 700 then branches back to event block 710. A similar event is the receipt of a request for listing information. Upon the occurrence of such an event, the method 700 may provide the listing information to the requesting user (advertiser or agent). (Block 760) The method 700 then branches back to event block 710. A request for contact information may be another event that may occur. Upon the occurrence of such an event, the method 700 may enable communications between advertiser and agent. (Block 770) The method 700 then branches back to event block 710.

Yet another event that may occur at event Block 710 is the receipt of an acceptance of an open offer by an agent. Upon the occurrence of such an event, the method 700 may notify contract formation operations (Recall, e.g., 315 of FIG. 3.) and/or update acceptance information (Recall, e.g., 310 of FIG. 3.). (Block 780) The agent listing may also be updated (e.g., to reflect the acceptance of an open offer) (Block 782), before the method 700 branches back to event block 710.

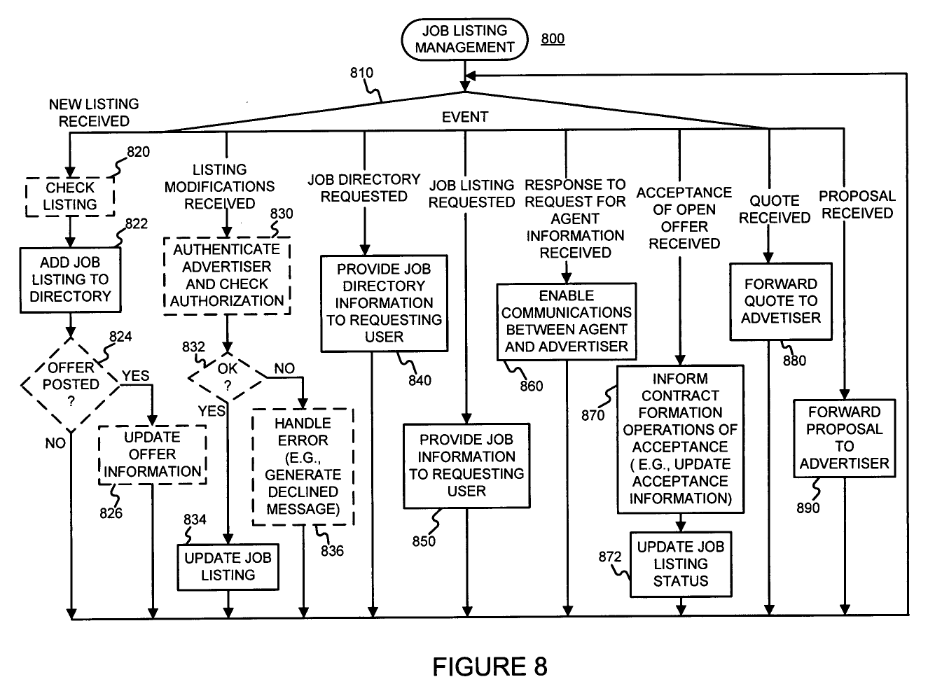

FIG. 8 is a flow diagram of an exemplary method 800 that may be used to perform job listing management (Recall, e.g., 215 of FIG. 2.) in a manner consistent with the present invention. Different branches of the method 800 may be performed in response to different events that may occur. (Block 810) One event that may occur is the receipt of new job listing information. If job listing information is received, the method 800 may check the job listing and add it to the directory. (Blocks 820 and 822) Furthermore, the method 800 may check if any offers are included in the listing. (Block 824) If not, the method 800 may simply branch back to event block 810. If, on the other hand, the job listing includes an offer, then the method 800 may update offer information (Recall, e.g., 305 of FIG. 3.) and branch back to event block 810. (Block 826)

Another event that may occur is the receipt of modifications made to the listing by an advertiser. If the modifications are received, the method 800 may check to authenticate the advertiser and examine their authorization. (Blocks 830 and 832) If the advertiser passes the check, the method 800 may simply update the job listing before branching back to event block 810. (Block 834) If, on the other hand, the advertiser does not pass the check, the method 800 may perform error handling procedures (e.g., provide an error message to the advertiser) before branching back to event block 810. (Block 836)

Receiving a request for the job directory may be another event that may occur at event block 810. If such a request is received, the method 800 may provide the job directory information to the requesting user (advertiser or agent) before branching back to event block 810. (Block 840) A similar event that may occur is the receipt of a request for a particular job listing. If such a request is received, the method 800 may provide the requested job listing information to the requesting user (advertiser or agent). (Block 850) The method 800 then branches back to event block 810.

Referring back to event block 810, if a response to a request for agent information is received, the method 800 may enable communication between an agent and an advertiser before the method 800 branches back to event block 810. (Block 860)

A further event that may occur at event block 810 is the receipt of an acceptance of an open offer. Upon the occurrence of this event, the method 800 may inform contract formation operations (Recall, e.g., 315 of FIG. 3.) of the acceptance (e.g., update acceptance information), and may update the job listing status to reflect the acceptance of an open offer. (Blocks 870 and 872) The method 800 then branches back to event block 810.

Agents can send quotes to the advertisers. This represents another event that may occur at event block 810. If a quote is received, the method 800 may simply forward the quote to the appropriate advertiser before branching back to event block 810. (Block 880) Referring back to event block 810, a proposal submitted by an agent may be received. If a proposal is received from an agent, the method 800 may forward it to the corresponding advertiser before branching back to event block 820. (Block 890)

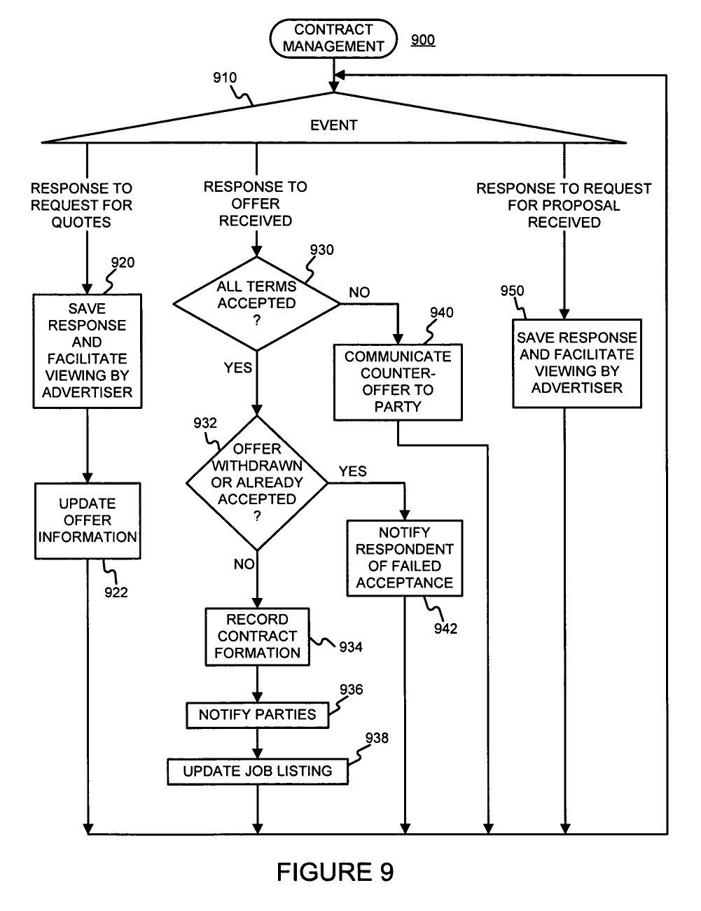

FIG. 9 is a flow diagram of an exemplary method 900 that may be used to perform contract management operations (Recall, e.g., 315 of FIG. 3.) in a manner consistent with the present invention. Different branches of the method 900 may be performed in response to different events that may occur. (Block 910) One of the events that may occur is the receipt of a response to a request for quotes. Upon the occurrence of this event, the method 900 may save the response and facilitate viewing by advertiser, and may update offer information (Recall, e.g., 305 of FIG. 3.). (Blocks 920 and 922) The method 900 then branches back to event block 910.

Referring back to event block 910, another event that may occur is the receipt of a response to an offer. Upon the occurrence of such an event, the method 900 may examine if all terms of the offer are accepted. (Block 930) If all the terms are not accepted, the method 900 may simply communicate a counter-offer to the party that made the offer, before branching back to event block 910. (Block 940) On the other hand, if all the terms are accepted, the method 900 may determine if the offer has been withdrawn or already accepted by another party. (Block 932) If the offer has been withdrawn or already accepted by another party, the method 900 may notify the respondent that its acceptance failed, before branching back to event block 910. (Block 942) If, on the other hand, the offer has not been withdrawn, nor already accepted, then the method 900 may record the contract information (Recall, e.g., 310, 315, and 355 of FIG. 3.), notify the parties, and update the associated job listing, before branching back to event block 910. (Blocks 934, 936, and 938)

Yet another event that may occur at the event block 910 is the receipt of a response to a request for proposals. If a response to a request for proposals is received, the method 900 may save the response and facilitate viewing by advertiser that issued the request for proposal before branching back to event block 910. (Block 950)

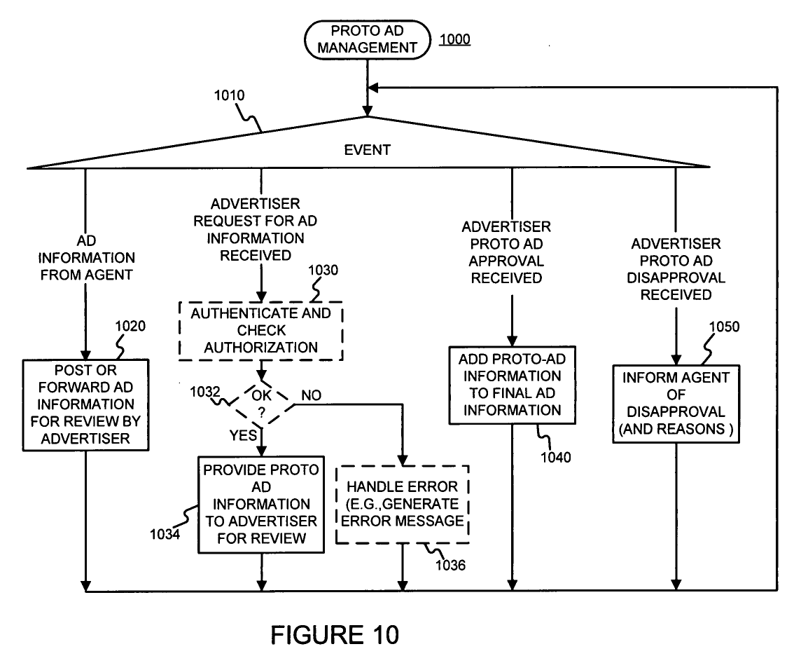

FIG. 10 is a flow diagram of an exemplary method 1000 that may be used to perform proto ad management (Recall, e.g., 325 and 335 of FIG. 3.) in a manner consistent with the present invention. Different branches of the method 1000 may be performed in response to different events that may occur. (Block 1010) One of the events that may occur is the receipt of ad information from an agent 130. If such ad information is received, the proto ad management method 1000 may post the ad(s) or forward them to the advertiser 110 for review before branching back to event block 1010. (Block 1020)

Another event that may occur is the receipt of an advertiser request for ad information. If such a request for ad information is received, the method 1000 may authenticate the advertiser and check their authorization. (Block 1030) If an advertiser is authorized to access and view the ad information, (Block 1032) then the method 1000 may provide proto ad information to the advertiser for review, before branching back to event block 1010. (Block 1034) If, on the other hand, the advertiser is unauthorized to access and view the ad information (Block 1032), then the method 1000 may perform error handling procedures (e.g., send an error message to the advertiser), before branching back to event block 1010. (Block 1036)

Referring back to event block 1010, another event that may occur is the receipt of advertiser proto ad approval. If the advertiser approves the proto ad, the method 1000 may provide the proto-ad information as final ad information (Recall, e.g., 350 of FIG. 3.). (Block 1040) The method 1000 then branches back to event block 1010.

Yet another event that may occur is the receipt of advertiser proto ad disapproval. If the advertiser disapproves the proto ad, the method 1000 may inform the agent of the disapproval and may provide the advertiser's reasons for the disapproval. (Block 1050) The method 1000 then branches back to event block 1010.

Referring back to block 1040, if the advertiser approves the ad, the proto ad management operations may forward it from the preliminary ad information 330 to the final ad information 350.

Referring back to block 1050, if the advertiser disapproves of the ad, the proto ad management operations may inform the agent of the disapproval and may also provide reasons of the disproval given by the advertiser. Furthermore, the advertiser may also contact the agent (e.g., through contact operations 205) so as to provide feedback information to the agent. Such information may be reason of disapproval, desired changes to be made to the ad, minor modifications, etc.

### §4.3.3 Exemplary Apparatus

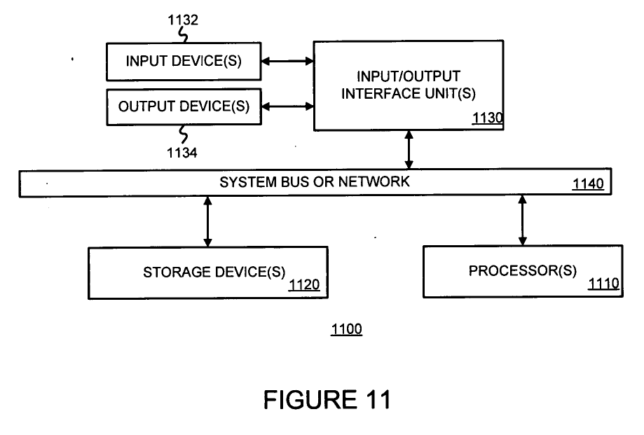

FIG. 11 is block diagram of a machine 1100 that may perform one or more of the operations discussed above. The machine 1100 basically includes one or more processors 1110, one or more input/output interface units 1130, one or more storage devices 1120, and one or more system buses and/or networks 1140 for facilitating the communication of information among the coupled elements. One or more input devices 1132 and one or more output devices 1134 may be coupled with the one or more input/output interfaces 1130.

The one or more processors 1110 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 1120 and/or may be received from an external source via one or more input interface units 1130.

In one embodiment, the machine 1100 may be one or more conventional personal computers. In this case, the processing units 1110 may be one or more microprocessors. The bus 1140 may include a system bus. The storage devices 1120 may include system memory, such as read only memory (ROM) and/or random access memory (RAM). The storage devices 1120 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1132, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1110 through an appropriate interface 1130 coupled to the system bus 1140. The output devices 1134 may include a monitor or other type of display device, which may also be connected to the system bus 1140 via an appropriate interface. In addition to (or instead of) the monitor, the personal computer may include other (peripheral) output devices (not shown), such as speakers and printers for example.

### §4.3.4 Alternatives and Extensions

The present invention is not limited to the particular embodiments described above. For instance, embodiments consistent with the present invention could include one or more of billing operations, email management systems, complaint handling processes, as well as job routing, performance rating and job tracking operations to monitor all activity on the business network. For example, detailed rating and ranking would help advertisers select the best agents. This rating system may include vertically specialized ranking, as well as other sub-categorizations to take into account all forms of specialization. This may also provide incentive for the best agents while essentially penalizing underperformers.

Furthermore, the present invention is not limited to ad authoring agents. For example, the business network could provide listings of agents for account creation, optimization and management operations, keyword selection operations, landing page testing, and other advertising services. Essentially, the principles of the present invention described in the context of ad authoring could be extended to other services involved in supporting and managing an advertiser's ads and campaigns from the creation to the full operation, support and management of them.

### §4.4 Conclusions

As can be appreciated from the foregoing, embodiments consistent with the present invention can be used to help advertisers to efficiently generate online ads, even complex ad creatives, and/or to efficiently manage ad campaigns, by using the assistance of advertising agents. As a result, the online ad business network may help to provide better, more sophisticated and higher quality advertising. Embodiments consistent with the present invention may be used to help advertisers and agents to enter into business relations satisfying all parties involved. The performance of agents may be tracked and monitored, and even provided to advertisers, to ensure quality of work performed by agents.

Advertisers should benefit by having ads that attract prospective consumers. Therefore, such ads should lead to better end user response to their products or services. Also, agents, particularly those with relevant experience and/or good reputation, should benefit by being able to offer their services to a receptive audience. Finally, ad delivery systems, and their partners, should benefit by providing their end users with better, more useful ads.

What is claimed is:

1. A computer-implemented method comprising:
a) providing a first interface for allowing agents to create and edit a listing;
b) storing a plurality of listings created via the first interface; and
c) providing a second interface for allowing advertisers to view the listings.

2. The computer-implemented method of claim 1 wherein at least one of the listings includes
i) a name of the agent or an agency to which the agent belongs,
ii) a location of the agent or the agency, and
iii) information about online advertising campaign experience of the agent or the agency.

3. The computer-implemented method of claim 2 wherein the information about online advertising campaign experience includes a number of advertising clients.

4. The computer-implemented method of claim 2 wherein the information about online advertising campaign experience includes an average monetary amount of ad campaigns handled by the agent or agency.

5. The computer-implemented method of claim 1 wherein at least one of the listings includes a computer-executable code element for initiating contact with an agent or agency associated with the listing.

6. The computer-implemented method of claim 1 wherein at least one of the listings includes a computer-executable code element for accepting, by an advertiser, an offer.

7. A computer-implemented method comprising:
a) providing a first interface for allowing advertisers to create and edit an advertising job listing;
b) storing a plurality of job listings created via the first interface; and
c) providing a second interface for allowing agents to view the job listings.

8. The computer-implemented method of claim 7 wherein at least one of the job listings includes a computer-executable code element for accepting requested agent information.

9. The computer-implemented method of claim 7 wherein at least one of the job listings includes a computer-executable code element for accepting an open offer to perform the job.

10. The computer-implemented method of claim 7 wherein at least one of the job listings includes a computer-executable code element for accepting a proposal from an agent to perform the job.

11. A computer-implemented method comprising:
a) providing a first interface for allowing agents to store preliminary adverting campaign information;
b) storing a plurality of sets of preliminary advertising campaign information stored via the first interface; and
c) providing a second interface for allowing advertisers to view at least one of the sets of preliminary advertising campaign information.

12. The computer-implemented method of claim 11 wherein the second interface further allows advertisers to comment on at least one of the sets of preliminary adverting campaign information.

13. The computer-implemented method of claim 11 wherein the second interface further allows advertisers revise at least one of the sets of preliminary adverting campaign information.

14. The computer-implemented method of claim 11 wherein the second interface further allows advertisers approve or disapprove at least one of the sets of preliminary adverting campaign information.

15. The computer-implemented method of claim 14 wherein if an advertiser approves of a set of preliminary advertising campaign information, then further changing the set of preliminary advertising campaign information to a final set of advertising campaign information.

16. The computer-implemented method of claim 11 wherein the preliminary advertising campaign information includes at least one ad creative.

17. The computer-implemented method of claim 11 wherein the preliminary advertising campaign information includes an ad landing page.

18. The computer-implemented method of claim 11 wherein the preliminary advertising campaign information includes serving constraints for targeting the serving of the ad.

19. The computer-implemented method of claim 11 wherein the preliminary advertising campaign information includes offer amount information for at least one of (A) an ad impression, (B) an ad selection, and (C) an ad conversion.

20. A computer-implemented method for use in an environment in which a business network facilitates business relationships or transactions between advertisers and agents for authoring advertisements and/or managing ad campaigns, the method comprising:
providing, by the business network, at least one of (A) compensation to the agent for the work done and (B) a subsidy to the advertiser.

21. The computer-implemented method of claim 20 wherein the business network provides compensation to the agent for the work done, the method further comprising:
accepting, by the business network, a payment from an advertiser for ad authoring and/or ad campaign management work done by an agent.

22. The computer-implemented method of claim 21 wherein an amount of the compensation is determined using an amount of the payment.

23 The computer-implemented method of claim 21 wherein the amount of the compensation is more than the amount of the payment.

24. The computer-implemented method of claim 21 wherein the amount of the compensation is less than the amount of the payment.

25. The computer-implemented method of claim 20 wherein the business network provides compensation to the agent for the work done, and
wherein an amount of the compensation includes a variable component.

26. The computer-implemented method of claim 25 wherein the variable component is determined using a performance of the ad campaign worked on by the agent.

27. The computer-implemented method of claim 26 wherein the performance is determined using at least one of ad impressions, an ad selection rate, an ad conversion rate, revenue generated from the ad campaign, and expected revenue generated by the ad campaign.

28. The computer-implemented method of claim 25 wherein the variable component is determined using a performance increase of the ad campaign worked on by the agent.

29. The computer-implemented method of claim 28 wherein the performance increase is determined using at least one of an increase in ad impressions, an increase in ad selection rates, an increase in ad conversion rates, an increase in revenue generated from the ad campaign, and an expected increase in revenue generated from the ad campaign.

30. The computer-implemented method of claim 20 wherein an amount of the compensation includes a variable component which includes a plurality of payments made at a plurality of different times.

31. The computer-implemented method of claim 20 wherein an amount of the compensation is provided to the agent for the work done and is negative at a point in time, such that the agent compensates the business network at that point in time.

32 The computer-implemented method of claim 21 wherein an amount of the compensation is determined by adding a predetermined amount to an amount of the payment.

33. The computer-implemented method of claim 21 wherein an amount of the compensation is determined by subtracting a predetermined amount from an amount of the payment.

34. The computer-implemented method of claim 21 wherein an amount of the compensation is determined by multiplying an amount of the payment by a factor that is greater than one.

35. The computer-implemented method of claim 21 wherein an amount of the compensation is determined by multiplying an amount of the payment by a factor that is less than one.

36. Apparatus comprising:
a) means for providing a first interface for allowing agents to create and edit a listing;
b) means for storing a plurality of listings created via the first interface; and
c) means for providing a second interface for allowing advertisers to view the listings.

37. Apparatus comprising:
a) means for providing a first interface for allowing advertisers to create and edit an advertising job listing;
b) means for storing a plurality of job listings created via the first interface; and
c) means for providing a second interface for allowing agents to view the job listings.

38. Apparatus comprising:
a) means for providing a first interface for allowing agents to store preliminary adverting campaign information;
b) means for storing a plurality of sets of preliminary advertising campaign information stored via the first interface; and
c) means for providing a second interface for allowing advertisers to view at least one of the sets of preliminary advertising campaign information.

39. Apparatus for use in an environment in which a business network facilitates business relationships or transactions between advertisers and agents for authoring advertisements and/or managing ad campaigns, the apparatus comprising:
means for providing, by the business network, at least one of (A) compensation to the agent for the work done and (B) a subsidy to the advertiser.

40. The apparatus of claim 39 wherein the business network provides compensation to the agent for the work done, the apparatus further comprising:
means for accepting, by the business network, a payment from an advertiser for ad authoring and/or ad campaign management work done by an agent.
